(19) United States
(12) Patent Application Publication
(10) Pub. No.: US 2026/0118284 A1
(43) Pub. Date: Apr. 30, 2026

(54) PATTERN INSPECTION METHOD AND SEMICONDUCTOR DEVICE MANUFACTURING METHOD INCLUDING THE SAME

(71) Applicant: Samsung Electronics Co., Ltd., Suwon-si (KR)

(72) Inventors: Jisung Cheon, Suwon-si (KR); Yeonhyu Kim, Suwon-si (KR); Taeksoo Shin, Suwon-si (KR); Mingyu Kim, Suwon-si (KR); Seongho Sim, Suwon-si (KR); Sungho Lee, Suwon-si (KR)

(21) Appl. No.: 19/290,707

(22) Filed: Aug. 5, 2025

(30) Foreign Application Priority Data
Oct. 29, 2024 (KR) 10-2024-0149994

(51) Int. Cl. G01N 21/95; G06T 7/00

(52) U.S. Cl. CPC G01N 21/9501; G06T 7/0004; G06T 2207/10061; G06T 2207/30148

(57) ABSTRACT

A method of inspecting a wafer having a pattern formed therein, the pattern including a hole that extends in a vertical direction, includes stacking a plurality of layers to form a stack and then removing a portion of the stack to form the pattern including the hole extending in the vertical direction, forming a conductive layer in the hole, the conductive layer having an internal space formed therein, removing a second portion of the stack to manufacture a sample, acquiring an image of the sample, analyzing the image, and obtaining an inspection result of the wafer based on the analyzing of the image.

### CROSS-REFERENCE TO RELATED APPLICATION

This application is based on and claims priority under 35 USC § 119 to Korean Patent Application No. 10-2024-0149994, filed on Oct. 29, 2024, in the Korean Intellectual Property Office, the disclosure of which is incorporated by reference herein in its entirety.

### BACKGROUND

Aspects of the inventive concept relate to a pattern inspection method and a semiconductor device manufacturing method including the same, and more particularly, to a pattern inspection method using an image and a semiconductor device manufacturing method including the pattern inspection method.

As the integration of semiconductor devices has increased, semiconductor devices with vertical structures, instead of conventional planar structures, have been proposed. Vertically structured semiconductor devices include a structure extending vertically on a substrate. However, as the integration of semiconductor devices has increased, the number of layers stacked in the vertical direction has also increased, and thus, a precise inspection method of semiconductor devices with a vertical structure is desirable.

### SUMMARY

Aspects of the inventive concept provide a pattern inspection method with increased reliability and a semiconductor device manufacturing method including the pattern inspection method.

In addition, the problems to be solved by the inventive concept are not limited to the problems mentioned above, and other problems may be clearly understood by those skilled in the art from the description below.

According to an aspect of the inventive concept, a method of inspecting a wafer having a pattern formed therein, the pattern including a hole that extends in a vertical direction, includes stacking a plurality of layers to form a stack and then removing a portion of the stack to form the pattern including the hole extending in the vertical direction; manufacturing a sample by forming a conductive layer in the hole, the conductive layer having an internal space formed therein; acquiring an image of the sample; analyzing the image; and obtaining an inspection result of the wafer based on the analyzing of the image.

According to another aspect of the inventive concept, a method of inspecting a wafer having a pattern formed therein, the pattern including a hole extending in a vertical direction, includes stacking a plurality of layers to form a stack and then removing a portion of the stack to form the pattern including the hole extending in the vertical direction; forming a conductive layer in the hole, the conductive layer having an internal space formed therein; removing a second portion of the stack to manufacture a sample; acquiring an image of the sample; analyzing the image; and obtaining an inspection result of the wafer based on the analyzing of the image, wherein, in the manufacturing of the sample by removing the portion of the stack, the conductive layer is exposed to an outside of the stack.

According to another aspect of the inventive concept, a method of manufacturing a semiconductor device, includes preparing a wafer; performing a semiconductor process on the wafer to form a pattern extending in a vertical direction perpendicular to a horizontal direction, the horizontal direction being parallel to a main surface of the wafer; inspecting the wafer on which the semiconductor process is performed; and performing a subsequent semiconductor process on the wafer, wherein the inspecting of the wafer includes: stacking a plurality of layers on the wafer to form a stack and then removing a portion of the stack to form a pattern including a hole that extends in the vertical direction; forming a conductive layer in the hole to manufacture a sample, the conductive layer having an internal space formed therein; acquiring an image of the sample; analyzing the image; and obtaining an inspection result of the wafer based on the analyzing of the image.

### BRIEF DESCRIPTION OF THE DRAWINGS

Embodiments will be more clearly understood from the following detailed description taken in conjunction with the accompanying drawings in which:

FIG. 1 is a flowchart illustrating a pattern inspection method according to an embodiment;

FIG. 2 is a diagram illustrating a pattern inspection device according to an embodiment;

FIG. 3 is a schematic diagram illustrating a scanning electron microscope (SEM) according to an embodiment;

FIGS. 4 and 5 are cross-sectional views illustrating a method of forming a pattern, according to an embodiment;

FIG. 6 is a flowchart illustrating a method of manufacturing a sample, according to an embodiment;

FIG. 7 is a cross-sectional view illustrating a method of manufacturing a sample, according to an embodiment;

FIG. 8 is a plan view illustrating a method of manufacturing a sample, according to an embodiment;

FIG. 9 is a cross-sectional view illustrating a result of performing delayering on a stack in a vertical direction, according to an embodiment;

FIG. 10 is a cross-sectional view illustrating a result of performing delayering on a stack in a horizontal direction, according to an embodiment;

FIG. 11 is a cross-sectional view illustrating a result of performing delayering on a stack in an oblique direction, according to an embodiment;

FIGS. 12 and 13 are diagrams illustrating an effect when a conductive layer is exposed to outside of a sample, according to an embodiment;

FIG. 14 is a schematic block diagram of a pattern inspection device according to an embodiment;

FIG. 15 is a flowchart illustrating a semiconductor device manufacturing method including a pattern inspection method according to an embodiment; and

FIGS. 16 and 17 are cross-sectional views illustrating subsequent processes for a semiconductor device, according to an embodiment.

### DETAILED DESCRIPTION OF THE EMBODIMENTS

Hereinafter, embodiments are described in detail with reference to the attached drawings. The same reference numerals are used for identical components in the drawing, and redundant descriptions thereof are omitted. In the drawings below, the thickness and size of each layer are exaggerated for convenience and clarity of description, and thus may differ somewhat from the actual shape and proportion.

Here, terms indicating spatial positions, such as “bottom,” “below,” “lower,” “upper,” and the like, are used only for the purpose of describing the relative positional relationship between elements or features depicted in the drawings, are for case of understanding only, and do not limit the technical idea of the inventive concept in any sense. Terms referring to relative positions in space are intended to encompass variations in the orientation of semiconductor devices other than those disclosed in the drawings. That is, semiconductor devices may be oriented in various directions during use (or during manufacture), and even in such cases, terms for positions used in this specification are readily understood by those skilled in the art.

Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

The thickness of a layer may refer to the dimension in the direction perpendicular to the surface of the layer. The direction perpendicular to the surface may refer to its average orientation and not include minor unintentional deviations (e.g., pits) that may be formed during a manufacturing process.

An item, layer, or portion of an item or layer described as “extending” or as extending “lengthwise” in a particular direction has a length in the particular direction and a width perpendicular to that direction, where the length is greater than the width.

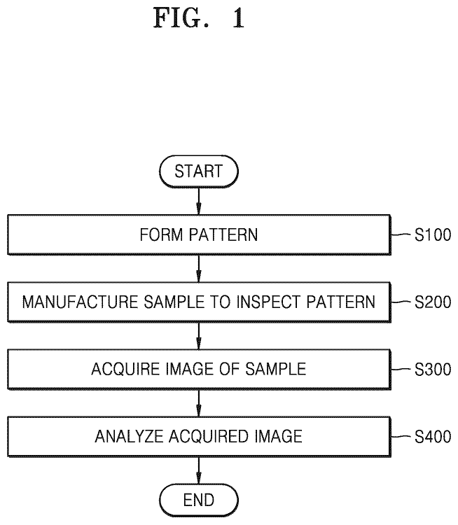

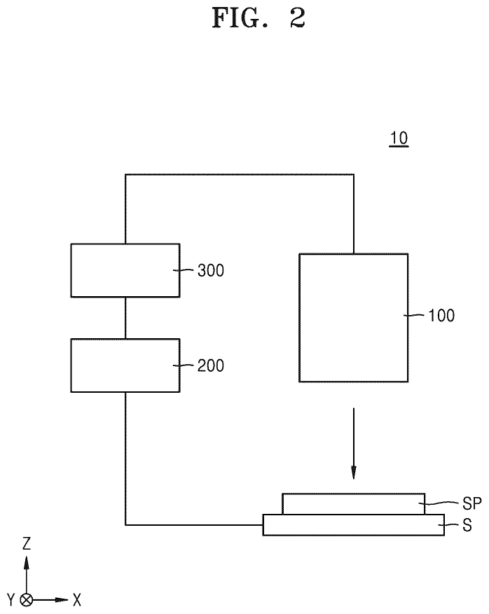

FIG. 1 is a flowchart illustrating a pattern inspection method according to an embodiment. FIG. 2 is a diagram illustrating a pattern inspection device 10 according to an embodiment.

Referring to FIGS. 1 and 2, a pattern may first be formed (S100). In an embodiment, the pattern inspection method of the inventive concept may be used to inspect a pattern of a semiconductor device. For example, the pattern inspection method of the inventive concept may be used to inspect a pattern of a hole structure of a semiconductor device. For example, the pattern inspection method of the inventive concept may be used to inspect a pattern of a memory semiconductor device.

In an embodiment, the pattern inspection method of the inventive concept may be used to inspect a pattern having a cross-section when viewed from a vertical direction (e.g., a plan view) which is polygonal, circular, elliptical, and/or irregular. As is described in detail below, in the pattern inspection method of the inventive concept, an image of a pattern may be acquired and then the image may be analyzed to determine whether the pattern is normal or defective.

The pattern inspection device 10 may inspect a pattern by using a pattern inspection method of the inventive concept. The pattern inspection device 10 may inspect a pattern included in a sample SP. For example, the pattern inspection device 10 may inspect a channel hole structure, a metal contact structure, a through-via structure, and/or a pillar-type capacitor structure of a semiconductor device. However, the technical idea of the inventive concept is not limited thereto, and the structures that the pattern inspection device 10 may inspect may vary.

Before describing the method of forming a pattern (S100), the pattern inspection device 10 is described hereinafter.

The pattern inspection device 10 may include an inspection device 100, a controller 200, and a processor 300. The inspection device 100 may be configured to acquire an image of the sample SP. For example, the inspection device 100 may include a scanning electron microscope (SEM) and/or a transmission electron microscope (TEM). In another embodiment, the inspection device 100 may include a scanning transmission electron microscope (STEM). However, the technical idea of the inventive concept is not limited thereto, and the inspection device 100 may include various devices capable of acquiring an image of the sample SP.

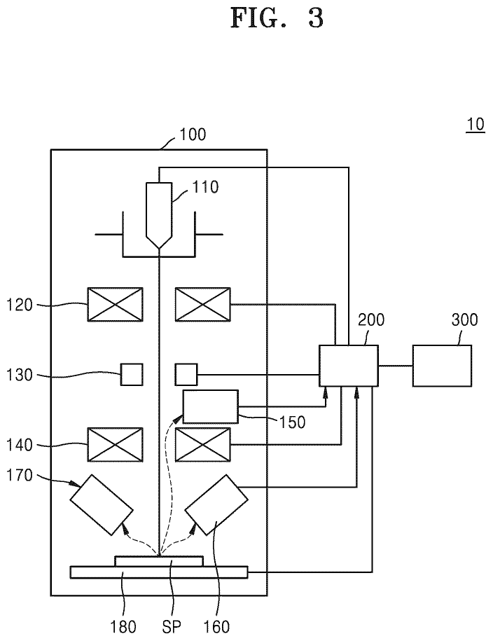

The SEM is a device that focuses electrons emitted from an electron gun using lenses to create electron beams, scans the electron beams across a sample to be inspected using a scanning coil, and detects secondary electrons (SE) and backscattered electrons (BSE) emitted from the sample to acquire an image of the sample. The SEM is described in more detail below with reference to FIG. 3.

The TEM is a device that focuses electrons emitted from an electron gun using lenses to create electron beams, causes the electron beams to pass through a sample to be inspected, and detects the electron beam transmitted through the sample through a screen or the like to acquire an image of the sample.

The controller 200 may be configured to control the operation of the inspection device 100. The controller 200 may control whether the inspection device 100 operates and/or control the inspection device 100 to inspect an inspection region of the sample SP.

The processor 300 may perform arithmetic operations on the image acquired by the inspection device 100. The processor 300 may determine whether the pattern is normal or defective based on the image acquired by the inspection device 100. In an embodiment, the processor 300 may process one or more SEM images generated by the inspection device 100.

The controller 200 and processor 300 may be implemented in hardware, firmware, software, or any combination thereof. For example, the controller 200 and the processor 300 may include computing devices, such as a workstation computer, a desktop computer, a laptop computer, or a tablet computer. For example, the controller 200 and the processor 300 may include a memory device, such as read-only memory (ROM), random access memory (RAM), and a processor configured to perform certain operations and algorithms, such as a microprocessor, a central processing unit (CPU), a graphics processing unit (GPU), etc. In addition, the controller 200 and processor 300 may include a receiver and a transmitter for receiving and transmitting electrical signals.

The pattern inspection device 10 may further include a stage S. The stage S may support the sample SP that is a measurement target. The stage S may move the sample SP in a horizontal direction (an X direction and/or Y direction) and/or a vertical direction (a Z direction) or rotate the sample SP about an axis extending in the vertical direction (the Z direction) so that the sample SP is aligned with respect to an optical system (i.e., an optical system including an electron gun, a focusing lens, a deflector, and/or an objective lens) that transmits an input electron beam.

In FIGS. 2 and 3, a direction parallel to an upper surface of the stage S is defined as the horizontal direction (the X direction and/or Y direction), and a direction perpendicular to the horizontal direction (the X direction and/or Y direction) is defined as the vertical direction (the Z direction).

FIG. 3 is a schematic diagram illustrating an SEM according to an embodiment. Descriptions are given with reference to FIG. 1.

In FIG. 3, an example in which the inspection device 100 is an SEM. However, as described above, the type of inspection device 100 is not limited thereto, and various devices may be used.

Referring to FIG. 3, the SEM 100 may be configured to measure the sample SP. According to embodiments, the SEM 100 may measure the sample SP on which a semiconductor device manufacturing process has been performed in a scanning manner. In an embodiment, the SEM 100 may obtain topographical information on the sample SP, morphological information, such as the shape and size of particles constituting the sample SP, and crystallographic information, such as the arrangement state of atoms in the sample SP, by measuring the sample SP. The SEM 100 may be referred to as the inspection device 100.

In an embodiment, the SEM 100 may irradiate an input electron beam IEB to the sample SP and detect emitted electrons EE emitted from the sample SP by interaction between the input electron beam IEB and the sample SP, thereby evaluating a semiconductor device manufacturing process performed on the sample SP. The emitted electrons EE may be generated by elastic scattering or inelastic scattering.

Elastic scattering is a phenomenon in which electrons included in the input electron beam IEB are directed in a direction opposite to the input direction of the input electron beam IEB, without any substantial change in the energy of the electrons included in the input electron beam IEB due to a potential of atomic nuclei constituting the sample SP. Electrons that escape from the sample SP surface by elastic scattering are called backscattered electrons, and the backscattered electrons may have energy of about 50 eV or more. The backscattered electrons may carry information about a structure and composition near the sample SP surface.

Inelastic scattering is a phenomenon in which electrons included in atoms in the sample SP are emitted due to interaction with electrons in electron orbits of atoms in the sample SP when electrons included in the input electron beam IEB are incident on the surface of the sample SP. By inelastic scattering, secondary electrons, Auger electrons, and X-rays may be emitted. Among the emitted electrons EE, the secondary electrons may have energies of several eV. The secondary electrons may carry information about roughness near a surface of each sample SP.

The secondary electrons are electrons bound to atoms in the sample SP emitted as free electrons as energy is transmitted to the electrons bound to atoms by the electrons included in the input electron beam IEB. When electrons at a low energy level other than a valence band are emitted as secondary electrons, electrons at a high energy level may move to a low energy level and X-rays may be emitted, and electrons excited by the X-rays and emitted from the wafer W may be Auger electrons. X-rays may include continuum X-rays and characteristic X-rays. The Auger electrons and X-rays may carry information about a composition and chemical bonding near the wafer W surface.

In addition, the SEM 100 may further detect signals based on incoherent elastic scattering, transmitted electrons, and cathodoluminescence.

The SEM 100 may include an electron gun 110, a focusing lens 120, a deflector 130, an objective lens 140, a first detector 150, and a second detector 160.

The electron gun 110 may generate and emit the input electron beam IEB. A wavelength of the input electron beam IEB may be determined by the energy of electrons emitted from the electron gun 110. In an embodiment, the wavelength of the input electron beam IEB may be several nm. In an embodiment, the electron gun 110 may be one of a cold field emission (CFE) type, a Schottky emission (SE) type, and a thermionic emission (TE) type.

The electron gun 110 may generate the input electron beam IEB by thermally or electrically applying energy higher than a work function (i.e., a difference value between the energy level in vacuum and the Fermi energy) to electrons included in a solid material, which is an electron source.

The focusing lens 120 may be located on a path of the input electron beam IEB between the electron gun 110 and the sample SP. In an embodiment, the focusing lens 120 may focus the input electron beam IEB onto the deflector 130. Accordingly, the controllability of the input electron beam IEB by the deflector 130 may be improved.

The deflector 130 may be located on the path of the input electron beam IEB between the focusing lens 120 and the sample SP. The deflector 130 may deflect the input electron beam IEB emitted from the electron gun 110. The deflector 130 may deflect the input electron beam IEB so that the input electron beam IEB, which has passed through the focusing lens 120, passes through the objective lens 140 and is irradiated to a set location on the sample SP. In an embodiment, the deflector 130 may scan the input electron beam IEB over the sample SP. The deflector 130 may be either an electric type or a magnetic type.

The objective lens 140 may be placed on the path of the input electron beam IEB between the deflector 130 and the sample SP. The objective lens 140 may focus the input electron beam IEB onto the sample SP. As the input electron beam IEB is confined to a narrow region on the sample SP, the resolution of the SEM 100 may be further improved.

In the above, a transmission system of the input electron beam IEB including the focusing lens 120, the deflector 130, and the objective lens 140 has been described, but this is a non-limiting example and does not limit the technical idea of the inventive concept in any sense. A person skilled in the art may readily be able to arrive at the transmission system for the input electron beam IEB including an additional focusing lens and an additional deflector based on what is described herein.

The first detector 150 and the second detector 160 may detect at least some of the emitted electrons EE reflected from the sample SP. For example, the first detector 150 may mainly detect back scattered particles emitted from the sample SP, and the second detector 160 may mainly detect secondary electrons emitted from the sample SP. SEM images may be acquired based on the emitted electrons EE detected by the first detector 150 and/or the second detector 160.

The SEM 100 may further include a third detector 170. The third detector 170 may detect Auger electrons and/or X-rays emitted from the sample SP. The SEM 100 may further include a stage 180. The stage 180 may support the sample SP that is a measurement target. The stage 180 may move the sample SP in the horizontal direction (the X direction and/or Y direction) and/or the vertical direction (the Z direction) and/or rotate the sample SP about an axis extending in the vertical direction (the Z direction) so that the sample SP is aligned with respect to the optical system (i.e., the optical system including the electron gun 110, the focusing lens 120, the deflector 130, and the objective lens 140) that transmits the input electron beam IEB. As described above, the stage 180 may be a component of the pattern inspection device 10.

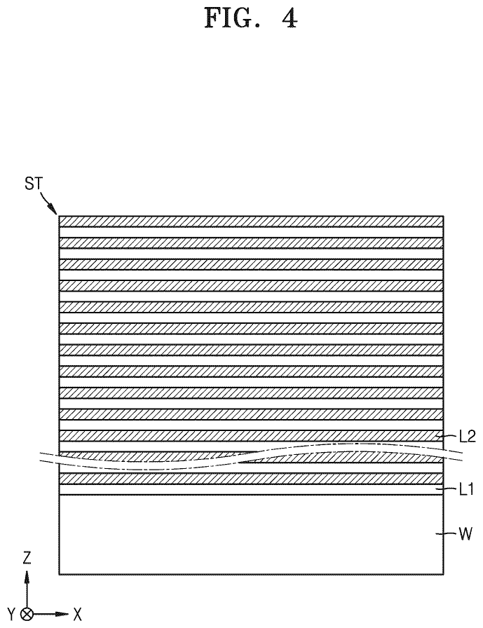

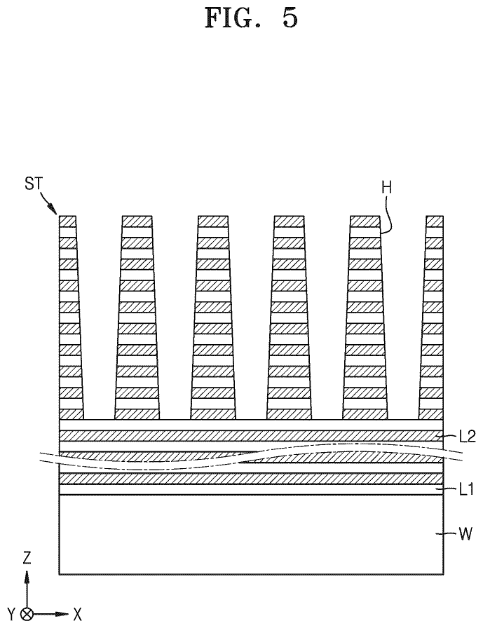

Forming a pattern (S100) is described with reference to FIGS. 4 and 5.

FIGS. 4 and 5 are cross-sectional views illustrating a method of forming a pattern according to an embodiment.

Referring to FIG. 4, a first layer L1 and a second layer L2 may be sequentially and alternately stacked in the vertical direction (the Z direction) on a wafer W. In an embodiment, a first layer L1 and a second layer L2 are formed on a wafer W, such that the first layer L1 and the second layer L2 may form a stack ST. For example, the first layer L1 may be a mold layer, and the second layer L2 may be an insulating layer. In another embodiment, the first layer L1 may be an insulating layer and the second layer L2 may be a mold layer. The first layer L1 and/or the second layer L2 may include an insulating material. Therefore, the stack ST may include an insulating material. For example, the first layer L1 may include silicon oxide, and the second layer L2 may include silicon nitride.

Hereinafter, a direction parallel to a main surface of the wafer W is defined as the horizontal direction (the X direction and/or Y direction), and a direction perpendicular to the horizontal direction (the X direction and/or Y direction) is defined as the vertical direction (the Z direction).

Referring to FIG. 5, at least a portion of the stack ST may be removed to generate a plurality of holes H. Each of the plurality of holes H may be formed to pass through (e.g., to extend into) the stack ST in the vertical direction (the Z direction) on the upper surface of the stack ST. That is, each of the plurality of holes H may be formed to extend in the vertical direction (the Z direction). In an embodiment, a photolithography patterning process may be performed on the stack ST to form a mask pattern, and at least a portion of the stack ST may be removed using the mask pattern as an etching mask to form the holes H.

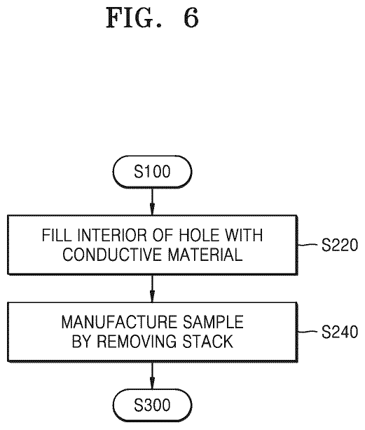

Referring back to FIG. 1, after the pattern is formed, the sample SP for inspecting the pattern may be manufactured (S200). After the pattern is formed, the sample SP may be formed by processing a portion of the pattern so that the pattern inspection device 10 may easily inspect the pattern. The method of manufacturing the sample SP is described with reference to FIGS. 6 to 8.

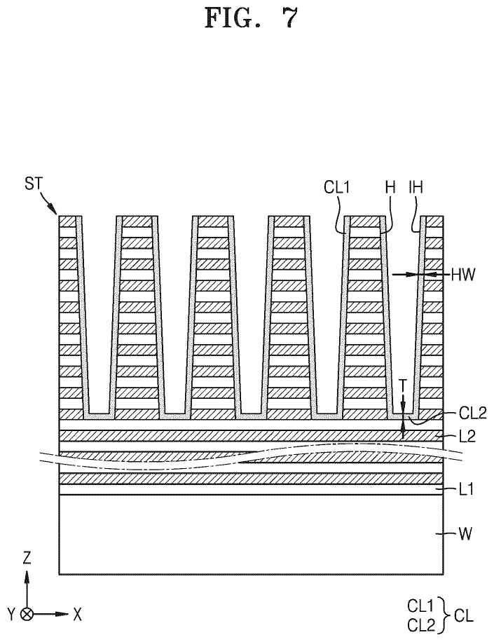

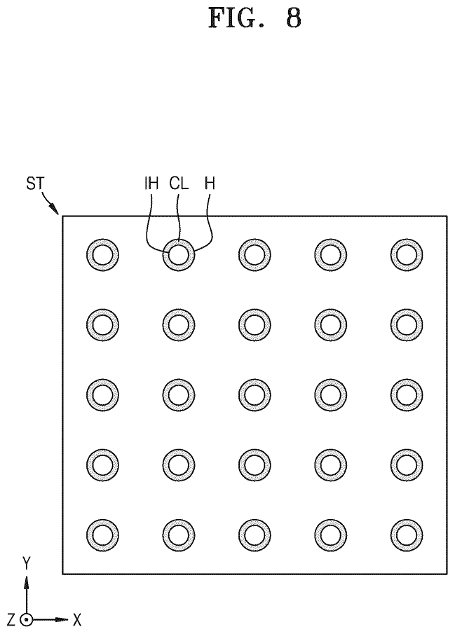

FIG. 6 is a flowchart illustrating a method of manufacturing the sample SP according to an embodiment. FIG. 7 is a cross-sectional view illustrating a method of manufacturing the sample ST according to an embodiment, and FIG. 8 is a plan view illustrating a method of manufacturing the sample ST according to an embodiment.

Referring to FIGS. 6 to 8, a conductive material may fill the interior of the hole H of the result of FIG. 5 (S220) to form a conductive layer CL. When a conductive material fills the interior of the hole H, a charging effect may be reduced so that errors may be reduced, when the hole H is inspected later using the pattern inspection device 10.

When the SEM and/or TEM analyzes the sample SP by making electrons incident, if the sample SP contains only a non-conductive material, the incident electrons may accumulate on the sample SP. This phenomenon may be referred to as the charging effect. Because the charging effect may occur and reduce the reliability of the pattern inspection method, the interior of the holes H may be filled with a conductive material to reduce the charging effect.

In an embodiment, a conductive layer CL may fill at least a portion of the interior of the hole H. In an embodiment, the top surface of the conductive layer CL may be positioned at the same vertical level as the top surface of the hole H. In an embodiment, the top surface of the conductive layer CL may be positioned at the same vertical level as the top surface of the stack ST. In an embodiment, the conductive layer CL may be formed inside the hole H, and an internal hole IH may be formed inside the conductive layer CL. For convenience of explanation, the hole H may be referred to as a first hole, and the internal hole IH may be referred to as a second hole. For example, the conductive layer CL may line the sides and/or bottom of the hole H, and the remaining portion of the hole H may be the internal hole IH.

For example, the conductive layer CL may cover a sidewall of the hole H and/or a bottom surface of the hole H. In an embodiment, the conductive layer CL disposed on the sidewall of the hole H may be referred to as a first portion CL1, and the conductive layer CL disposed on a bottom surface of the hole H may be referred to as a second portion CL2. The first portion CL1 and the second portion CL2 are merely formally distinguished from each other for explanatory purposes and may include identical components.

In an embodiment, the first portion CL1 may have a horizontal width HW in the horizontal direction (the X direction and/or Y direction), and the second portion CL2 may have a vertical thickness T in the vertical direction (the Z direction). The vertical thickness T of the second portion CL2 may be greater than the horizontal width HW of the first portion CL1. For example, the vertical thickness T of the second portion CL2 may be equal to or smaller than twice the horizontal width HW of the first portion CL1. For example, the horizontal width HW of the first portion CL1 may be about 30 Å or less. For example, the vertical thickness T of the second portion CL2 may be about 60 Å or less.

In an embodiment, the conductive layer CL may be formed conformally on the sidewall of the hole H. For example, the conductive layer CL may be formed with a constant horizontal width HW on the sidewall of the hole H. In an embodiment, the conductive layer CL may be formed by a diffusion process inside the hole H. In an embodiment, the conductive layer CL may be formed by a deposition process inside the hole H.

The conductive layer CL may include at least one selected from a metal (e.g., tungsten, copper, aluminum, etc.), a conductive metal nitride (e.g., titanium nitride, tantalum nitride, etc.), or a transition metal (e.g., titanium, tantalum, etc.). In addition, the conductive layer CL may support the hole H structure in the sample SP not to collapse.

After the interior of the hole H is filled with a conductive material (S220), at least a portion of the stack ST may be removed to form the sample SP (S240). In an embodiment, the sample SP may be formed by delayering the results of FIGS. 7 and 8. Delayering may be a process of removing layers or slices of a semiconductor device to facilitate inspection of the semiconductor device. Delayering may be a type of portion removal, including removing a portion of the semiconductor device along a plane.

For example, delayering may be performed by a focused ion beam FIB, photolithography, etching, and/or chemical mechanical polishing (CMP). For example, the surface of the sample SP may be processed by scanning an ion beam onto the surface of the sample SP. This may be called FIB milling.

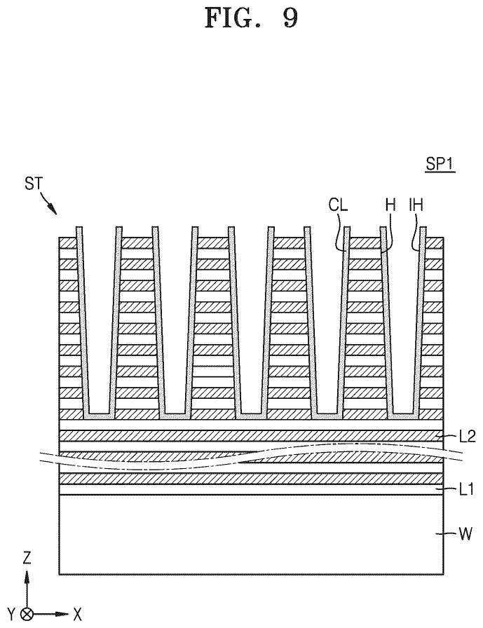

In an embodiment, delayering may be performed on the results of FIGS. 7 and 8 so that the pattern inspection device 10 may easily analyze the sample SP at a later time. In an embodiment, delayering may be performed in the vertical direction (the Z direction) on the results of FIGS. 7 and 8 so that the pattern inspection device 10 may easily analyze the sample SP at a later time. For example, at least a portion of each of the stack ST and/or the conductive layer CL may be removed in the vertical direction (the Z direction). The results of performing delayering on the results of FIGS. 7 and 8 in the vertical direction (the Z direction) are described in more detail below with reference to FIG. 9.

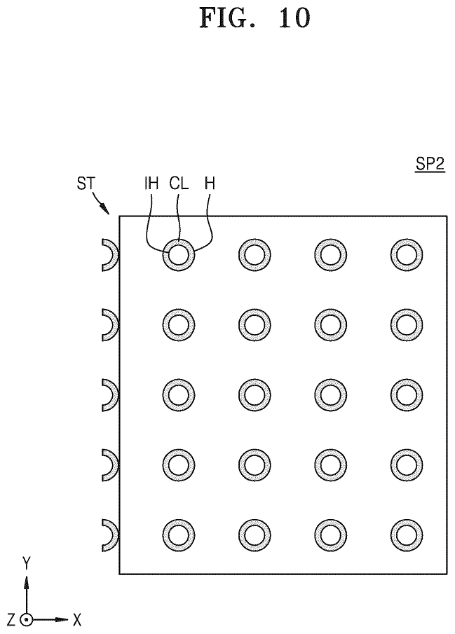

In another embodiment, delayering may be performed on the results of FIGS. 7 and 8 in the horizontal direction (the X direction and/or Y direction) so that the pattern inspection device 10 may easily analyze the sample SP at a later time. For example, at least a portion of each of the stack ST and/or the conductive layer CL may be removed in the horizontal direction (the X direction and/or Y direction). The results of performing delayering on the results of FIGS. 7 and 8 in the horizontal direction (the X direction and/or Y direction) are described in more detail in FIG. 10.

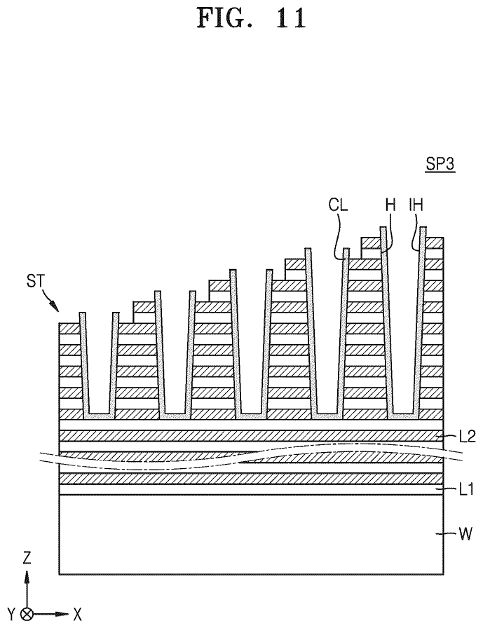

In another embodiment, delayering may be performed on the results of FIGS. 7 and 8 in the oblique direction so that the pattern inspection device 10 may easily analyze the sample SP at a later time. Here, the oblique direction refers to a direction that is not parallel to the horizontal direction (the X direction and/or Y direction) and not parallel to the vertical direction (the Z direction). For example, at least a portion of each of the stack ST and/or the conductive layer CL may be removed in the oblique direction. The results of performing delayering on the results of FIGS. 7 and 8 in the oblique direction are described in more detail below with reference to FIG. 11.

FIG. 9 is a cross-sectional view illustrating a result of performing delayering on the stack ST in the vertical direction according to an embodiment.

Referring to FIG. 9, delayering may be performed on the stack ST so that at least a portion of the stack ST is removed in the vertical direction (the Z direction). The sample SP formed by performing delayering on the stack ST in the vertical direction (the Z direction) may be referred to as a first sample SP1. During delayering of the stack ST, at least a portion of the conductive layer CL may also be removed. When delayering is performed in the vertical direction (the Z direction), delayering may be performed down to a certain target layer of the stack ST. For example, the elements present at the same vertical level as each other may be removed in the delayering process. For example, some or all of the elements present at the same vertical level as each other may be removed in the delayering process. Layers may be removed sequentially in a downward direction. For example, a topmost layer of the stack ST may be removed, then the next highest layer may be removed, and so on, down to a target level. The removed portion (prior to its removal) may extend in a horizontal plane and may have a thickness in the vertical direction. When delayering is performed in the vertical direction (the Z direction), a plan view of the pattern may be acquired later and the pattern may be analyzed. In the case of acquiring the plan view of the pattern by performing delayering in the vertical direction (the Z direction), a plan view of the holes H located at the same vertical level may be acquired.

During the delayering process, a removal rate of the stack ST may be different from a removal rate of the conductive layer CL. In an embodiment, an etch rate of the stack ST may be different from an etch rate of the conductive layer CL. In an embodiment, the removal rate of the stack ST may be higher than the removal rate of the conductive layer CL. For example, the etch rate of the stack ST may be higher than the etch rate of the conductive layer CL.

As illustrated in FIG. 7, when the top surface of the stack ST is positioned at the same vertical level as that of the top surface of the conductive layer CL, if delayering is performed in the vertical direction (the Z direction), the top surface of the conductive layer CL may be positioned at a higher vertical level than the top surface of the stack ST.

FIG. 10 is a cross-sectional view illustrating a result of performing delayering on a stack in the vertical direction according to an embodiment.

Referring to FIG. 10, delayering may be performed on the stack ST so that at least a portion of the stack ST is removed in the horizontal direction (the X direction and/or Y direction). The sample SP formed by performing delayering on the stack ST in the horizontal direction (the X direction and/or Y direction) may be referred to as a second sample SP2. During delayering of the stack ST, at least a portion of the conductive layer CL may also be removed. When delayering is performed in the horizontal direction (the X direction and/or Y direction), delayering may be performed up to a certain target layer of the stack ST. For example, the elements present at the same horizontal position as each other may be removed in the delayering process. For example, some or all of the elements present at the same horizontal position as each other may be removed in the delayering process. Layers or slices may be removed sequentially in a horizontal direction. For example, a leftmost slice of the stack ST may be removed, then the next leftmost slice may be removed, and so on, to a target horizontal position. The removed portion (prior to its removal) may extend in a vertical plane and may have a thickness in the horizontal direction. If delayering is performed in the horizontal direction (the X direction and/or Y direction), a cross-sectional view of the pattern may be acquired later so that the pattern may be analyzed.

As described above, during the delayering process, a removal rate of the stack ST may be different from a removal rate of the conductive layer CL. In an embodiment, an etch rate of the stack ST may be different from an etch rate of the conductive layer CL. In an embodiment, the removal rate of the stack ST may be higher than the removal rate of the conductive layer CL. For example, the etch rate of the stack ST may be higher than the etch rate of the conductive layer CL.

FIG. 11 is a cross-sectional view illustrating a result of performing delayering on the stack ST in the oblique direction according to an embodiment.

Referring to FIG. 11, delayering may be performed on the stack ST so that at least a portion of the stack ST may be removed in the oblique direction. The sample SP formed by performing delayering on the stack ST in the oblique direction may be referred to as a third sample SP3. During delayering of the stack ST, at least a portion of the conductive layer CL may also be removed. For example, the stack ST may be divided into sections that extend in the Y direction and that are arranged in the X direction. The delayering process may be performed on a first section down to a first target level. The delayering process may be performed on an adjacent second section down to a second target level that is higher or lower than the first target level. The target level for each section may gradually change from one end of the stack ST to the other end of the stack ST in the X direction as shown, e.g., in FIG. 11. In this manner, the topmost layers of the sections of the stack ST remaining after the delayering process may be arranged along an oblique plane. For example, upper surfaces of the sections of the stack ST may form a staircase shape when viewed along the Y direction. If delayering is performed in the oblique direction, a plan view of the pattern may be acquired later and the pattern may be analyzed. In the case of acquiring the plan view by performing delayering in the oblique direction, a plan view of the holes H located at various vertical levels may be acquired.

As described above, during the delayering process, a removal rate of the stack ST may be different from a removal rate of the conductive layer CL. In an embodiment, an etch rate of the stack ST may be different from an etch rate of the conductive layer CL. In an embodiment, the removal rate of the stack ST may be higher than the removal rate of the conductive layer CL. For example, the etch rate of the stack ST may be higher than the etch rate of the conductive layer CL.

The conductive layer CL may be formed on the surface of the sample SP manufactured by the above method. In addition, as described above, in the process of removing at least a portion of the sample SP, because the removal rate of the stack ST is different from the removal rate of the conductive layer CL, a portion of the conductive layer CL may be exposed. That is, the conductive layer CL may be exposed to the outside of the stack ST.

During the process of inspecting the sample SP, charged electrons on the surface of the sample SP may be grounded by the conductive layer CL. That is, the conductive layer CL of the sample SP may provide a ground path. Therefore, the reliability of the inspection for the sample SP may increase. The fact that the sample SP is inspected with high reliability due to the conductive layer CL exposed on the sample SP is described in more detail below with reference to FIGS. 10 and 11.

In addition, SEM images of horizontal cross-sections, vertical cross-sections, and/or oblique cross-sections of the sample SP may be acquired. Therefore, the pattern may be easily inspected by acquiring information on various cross-sections of the sample SP. For example, different samples SP (e.g., a first sample, a second sample, and/or a third sample) may be manufactured in different portions of the stack that have exposed cross-sections, and each of the samples SP may be inspected to acquire different information.

Referring back to FIG. 1, after the sample SP is manufactured (S200), an image of the sample SP may be acquired (S300). The image of the sample SP may be acquired by imaging the sample SP using the inspection device 100 described above with reference to FIG. 1. In an embodiment, the image of the sample SP may be acquired by imaging the sample SP using the SEM described above with reference to FIG. 3. For example, the image of the sample SP may include an SEM image. However, the technical idea of the inventive concept is not limited thereto, and various images may be acquired for analyzing the sample SP.

As described above, at least a portion of the sample SP may be removed to expose the conductive layer CL to the outside of the stack ST on an inspection surface. For example, a portion of the conductive layer CL in each of the holes H may protrude above an upper surface of the surrounding portion of the stack ST after the delayering process is performed as shown, e.g., in FIGS. 9 and 11. As another example, a portion of the conductive layer CL in some of the holes H may protrude from a side surface of the stack ST after the delayering process is performed as shown, e.g., in FIG. 10. When the conductive layer CL is exposed to the outside of (e.g., protruding from) the stack ST in the cross-section, the emitted electrons EE emitted from the sample SP may be easily detected. That is, when the conductive layer CL is exposed to the outside of (e.g., protruding from) the stack ST at the inspection cross-section, secondary electrons SE and/or back scattered electrons BSE emitted from the sample SP may be easily detected.

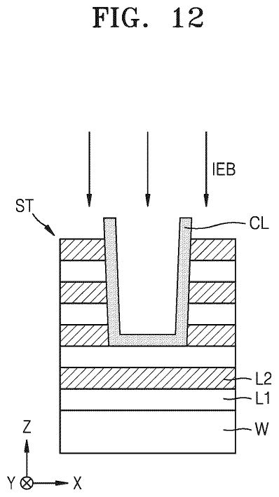

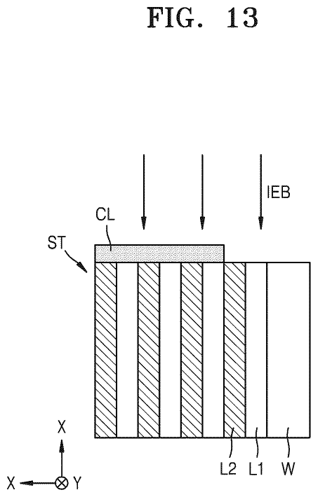

FIGS. 12 and 13 are diagrams illustrating the effect when the conductive layer is exposed to the outside of the sample SP, according to an embodiment. FIG. 12 illustrates a cross-section of the sample SP formed by performing delayering in the vertical direction (the Z direction) as exemplified in FIG. 9, and FIG. 13 illustrates a cross-section of the sample SP formed by performing delayering in the horizontal direction (the X direction and/or Y direction) as exemplified in FIG. 10.

Referring to FIGS. 12 and 13, the conductive layer CL may be exposed on the inspection surface of the sample SP. As described above with reference to FIGS. 1 and 3, the inspection device 100 may inspect the sample SP by irradiating the sample SP with the input electron beam IEB and detecting the emitted electrons EE emitted from the sample SP by interaction between the input electron beam IEB and the sample SP.

When the conductive layer CL is exposed on the inspection surface of the sample SP, the emitted electrons EE generated on the surface of the sample SP may be easily detected. In more detail, when the conductive layer CL is exposed on the inspection surface of the sample SP, the conductive layer CL may provide a ground path through which charged electrons on the surface of the sample SP may be emitted. Therefore, the charged electrons on the surface of the sample SP may be removed. Because the charged electrons on the surface of the sample SP are removed, the interference in the path of the emitted electrons EE may be reduced. Therefore, the inspection device 100 may acquire a clearer image.

Referring back to FIG. 1, after the image of the sample SP is acquired (S300), the acquired image may be analyzed (S400). The method of analyzing the sample image is described separately by two cases of FIGS. 9 to 11.

First, a case in which a plan view is acquired for the sample SP delayered in the vertical direction (the Z direction) as illustrated in FIG. 9 is described. A sample image may include information on the top surface of the holes H. For the sample image, a diameter of the hole H, a pitch of the holes H, a critical dimension (CD) of the hole H, and a horizontal distance between the holes H may be analyzed. However, the parameters for inspecting the sample image are not limited thereto, and various types of parameters may be inspected.

As described above, because the sample SP is acquired by performing delayering in the vertical direction (the Z direction), the holes H located at the same vertical level on the sample image may be inspected.

In addition, a case in which a cross-sectional view is obtained for the sample SP delayered in the horizontal direction (the X direction and/or Y direction) as illustrated in FIG. 10 is described. A sample image may include information on the sides of the holes H. For the sample image, a horizontal distance between the holes H and/or a vertical height of the hole H may be analyzed. However, the parameters for inspecting the sample image are not limited thereto, and various types of parameters may be inspected.

Finally, a case in which a plan view of the sample SP delayered in the oblique direction as shown in FIG. 11 is acquired is described. A sample image may include information on the top surface of multiple holes H. For the sample image, a diameter of the hole H, a pitch of the holes H, a critical dimension of the hole H, and/or a horizontal distance between the holes H may be analyzed. However, the parameters for inspecting the sample image are not limited thereto, and various types of parameters may be inspected.

As described above, because the sample SP is acquired by performing delayering in the oblique direction, holes H arranged at various vertical levels on the sample image may be inspected.

Accordingly, the pattern inspection device 10 according to an embodiment may obtain an image (e.g., an SEM image) of the pattern and easily acquire a large amount of information on the vertical structure of the image (e.g., an SEM image). Therefore, the pattern of the sample SP may be statistically analyzed.

In addition, the semiconductor device inspection method according to aspects of the inventive concept may provide an inspection method with a reduced process turn around time (TAT) by reducing the sample SP processing time. In addition, the semiconductor device inspection method according to aspects of the inventive concept may provide a method of rapidly inspecting a semiconductor device including an in-line inspection method.

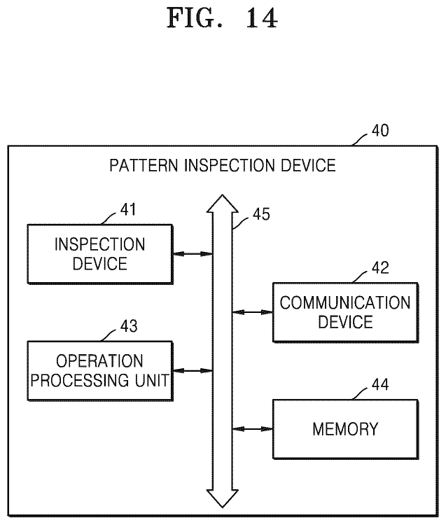

FIG. 14 is a schematic block diagram of a pattern inspection device 40 according to an embodiment. Descriptions are given with reference to FIGS. 1 to 13.

Referring to FIG. 14, the pattern inspection device 40 may include an inspection device 41, a communication device 42, an operation processing unit 43, a memory 44, and a bus 45. However, the components included in the pattern inspection device 40 are not limited to the components listed above, and the pattern inspection device 40 may include various components for inspecting a pattern. The components of the pattern inspection device 40 may communicate with each other through a bus 45.

The inspection device 41 may measure the sample SP including a pattern. For example, the inspection device 41 may include a SEM, a TEM and/or a STEM. The inspection device 41 may acquire an image of the sample SP. For example, the inspection device 41 may obtain an SEM image, a TEM image, and/or a STEM image of the sample SP.

The communication device 42 may provide network communication for the pattern inspection device 40. The network may be a wired network and/or a wireless network, such as radio, cellular, satellite, broadcast, etc. In an embodiment, the pattern inspection device 40 may be an electrical device equipped with an image processing program, such as a computer, a smartphone, a personal computer, or a server.

The operation processing unit 43 may perform an arithmetic operation on the image acquired by the inspection device 41. The operation processing unit 43 may inspect the pattern based on the image acquired by the inspection device 41. The operation processing unit 43 may perform preprocessing on the image acquired by the inspection device 41 and calculate parameters for inspecting the pattern. For example, the parameters may include the diameter of the hole H, the pitch of the hole H, the critical dimension of the hole H, the horizontal distance between the holes H, and/or the vertical depth of the hole H. The operation processing unit 43 may compare the inspection parameters with reference values to determine whether the sample SP is normal or defective.

For example, the operation processing unit 43 may include a central processing unit (CPU), a graphics processing unit (GPU), a vector processor, a quantum operation processing unit, an embedded operation processing unit, etc.

The memory 44 may store data calculated by the operation processing unit 43. The memory 44 may store data acquired by the inspection device 41. For example, the memory 44 may include flash memory, hard disk drive (HDD), solid state drive (SSD), dynamic random-access memory (DRAM), static random-access memory (SRAM), etc.

Any one or more of the elements of the pattern inspection device 40 may be, or may be included in, a computer (or several interconnected computers) and may include, for example, one or more processors configured by software, such as a CPU (Central Processing Unit), GPU (graphics processor), controller, etc., forming various functional modules of the computer. The computer may be a general purpose computer or may be dedicated hardware or firmware (e.g., an electronic or optical circuit, such as application-specific hardware, such as, for example, a digital signal processor (DSP) or a field-programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) may each correspond to a separate segment or segments of software (e.g., a subroutine) which configure the computer, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script.

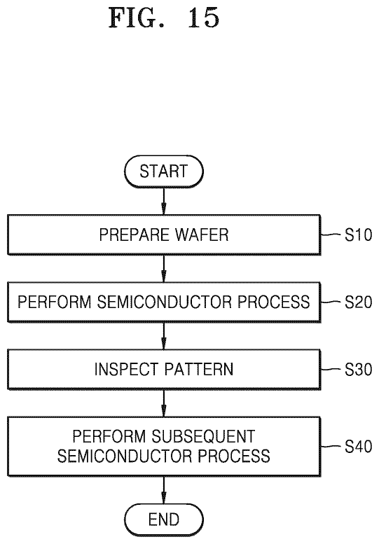

FIG. 15 is a flowchart illustrating a semiconductor device manufacturing method including a pattern inspection method according to an embodiment. Descriptions are given with reference to FIGS. 1 to 14.

Referring to FIG. 15, first, a wafer W may be prepared (S10). The wafer W may include, for example, a bare wafer on which one or more semiconductor processes have been performed or on which no semiconductor processes have been performed.

Thereafter, a semiconductor process may be performed on the wafer W (S20). An oxidation process, a photo process, a deposition process, an etching process, an ion process, and/or a cleaning process may be performed on the wafer W. The semiconductor process may be performed on the wafer to form a pattern on the wafer. The operation (S20) in which a semiconductor process is performed on the wafer W may include the operation (S100) of forming a pattern of FIG. 1. In an embodiment, after forming a plurality of layers on the wafer W, at least a portion of the layers may be removed in the vertical direction (the Z direction) so that a pattern extending in the vertical direction (the Z direction) may be formed.

Thereafter, pattern inspection may be performed (S30). The operation (S30) of inspecting a pattern may include the operation (S200) of manufacturing the sample SP for inspecting the pattern of FIG. 1, the operation (S300) of acquiring an image of the sample SP, and the operation (S400) of analyzing the acquired image. The operation (S200) of manufacturing the sample SP may include the operation (S220) in FIG. 6 of forming a conductive layer including the internal hole IH inside the hole H and the operation (S240) in FIG. 6 of removing at least a portion of the stack ST.

Thereafter, a subsequent semiconductor process may be performed on the wafer W (S40). The subsequent semiconductor processes for the wafer W may include various processes. For example, the subsequent semiconductor processes may include an oxidation process, a photo process, a deposition process, an etching process, an ion process, and/or a cleaning process. In addition, the subsequent semiconductor processes may include a singulation process of individualizing the wafer W into individual semiconductor chips, a test process of testing the semiconductor chips, and a packaging process of packaging the semiconductor chips. A semiconductor device may be completed through the subsequent semiconductor processes on the wafer W.

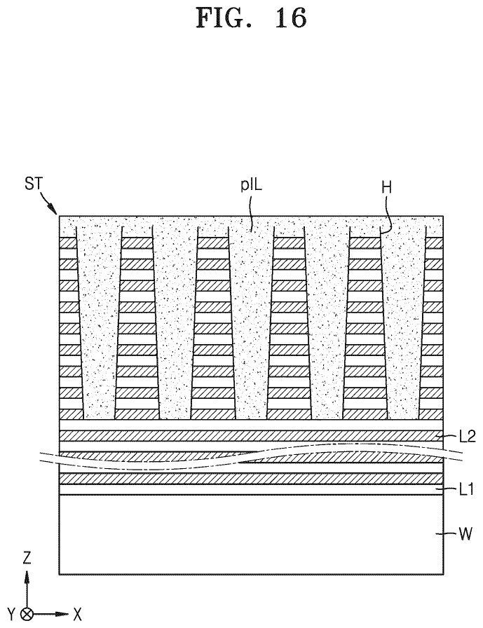

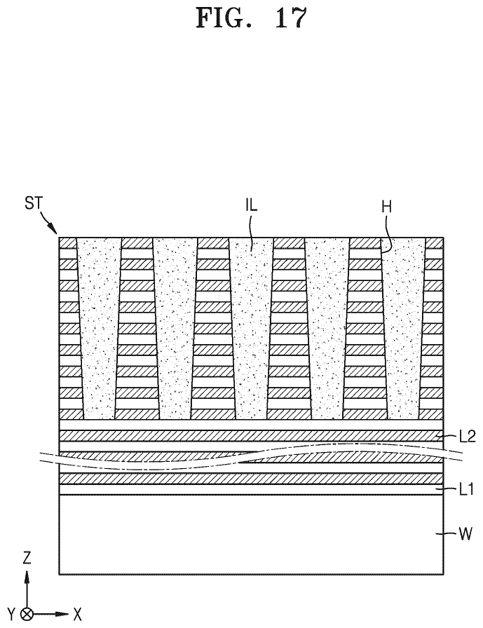

In an embodiment, the subsequent semiconductor processes on the wafer W may be performed by forming an additional insulating layer IL (see FIG. 17) inside the hole H. The process of forming the additional insulating layer IL (see FIG. 17) inside the hole H is described with reference to FIGS. 16 and 17.

FIGS. 16 and 17 are cross-sectional views illustrating the subsequent processes for a semiconductor device according to an embodiment. Descriptions are given with reference to FIG. 9.

Referring to FIG. 16, the conductive layer CL may be removed and a preliminary additional insulating layer pIL may be formed inside the hole H. For example, the preliminary additional insulating layer pIL may be formed by a deposition process. The preliminary additional insulating layer pIL may cover the interior of the hole H and the upper surface of the stack ST.

For example, the preliminary additional insulating layer pIL may include silicon nitride (SIN), oxide and/or polysilicon. The preliminary additional insulating layer pIL may be formed in a region from which the conductive layer CL was removed in FIGS. 9 to 12.

Referring to FIG. 17, a portion of the preliminary additional insulating layer pIL of FIG. 16 may be removed to form the additional insulating layer IL. A portion of the preliminary additional insulating layer pIL of FIG. 16 may be removed by a CMP process. In addition, a cleaning process and an etching process may be additionally performed on the preliminary additional insulating layer pIL of FIG. 16.

When at least a portion of the preliminary additional insulating layer pIL is removed, the top surface of the stack ST, the top surface of the hole H and/or the top surface of the additional insulating layer IL may be positioned at the same vertical level.

While the inventive concept has been particularly shown and described with reference to embodiments thereof, it will be understood that various changes in form and details may be made therein without departing from the spirit and scope of the inventive concept.

What is claimed is:

1. A method of inspecting a wafer having a pattern formed therein, the pattern including a hole that extends in a vertical direction, the method comprising:
stacking a plurality of layers to form a stack and then removing a portion of the stack to form the pattern including the hole extending in the vertical direction;
manufacturing a sample by forming a conductive layer in the hole, the conductive layer having an internal space formed therein;
acquiring an image of the sample;
analyzing the image; and
obtaining an inspection result of the wafer based on the analyzing of the image.

2. The method of claim 1, wherein the conductive layer covers a sidewall of the hole.

3. The method of claim 2, wherein the conductive layer conformally covers the sidewall of the hole.

4. The method of claim 1, wherein the manufacturing of the sample includes removing a second portion of the stack.

5. The method of claim 4, wherein
the removing of the second portion of the stack includes:
removing the second portion of the stack in the vertical direction such that the removed second portion extends in a horizontal plane and has a thickness in the vertical direction,
removing the second portion of the stack in a horizontal direction parallel to a main surface of the stack such that the second portion extends in a vertical plane and has a thickness in the horizontal direction, or
removing the second portion of the stack in an oblique direction that is not parallel to each of the horizontal direction and the vertical direction such that the stack is divided into sections extending in the horizontal direction, such that upper surfaces of the sections form a staircase shape when viewed along the horizontal direction.

6. The method of claim 4, wherein a removal rate of the stack is different from a removal rate of the conductive layer.

7. The method of claim 1, wherein the image includes at least one of a scanning electron microscope (SEM) image, a transmission electron microscope (TEM) image, or a scanning transmission electron microscope (STEM) image.

8. A method of inspecting a wafer having a pattern formed therein, the pattern including a hole extending in a vertical direction, the method comprising:
stacking a plurality of layers to form a stack and then removing a portion of the stack to form the pattern including the hole extending in the vertical direction;
forming a conductive layer in the hole, the conductive layer having an internal space formed therein;
removing a second portion of the stack to manufacture a sample;
acquiring an image of the sample;
analyzing the image; and
obtaining an inspection result of the wafer based on the analyzing of the image,
wherein, in the manufacturing of the sample by removing the portion of the stack, the conductive layer is exposed to an outside of the stack.

9. The method of claim 8, further comprising removing a portion of the conductive layer before the acquiring of the image of the sample.

10. The method of claim 9, wherein a removal rate of the conductive layer is less than a removal rate of the stack.

11. The method of claim 8, wherein the stack is removed in the vertical direction, and the analyzing of the image is performed based on at least one of a diameter of a feature of the pattern, a critical dimension (CD) of the feature of the pattern, a pitch of the feature of the pattern, and a horizontal distance between adjacent features of the pattern.

12. The method of claim 8, wherein the stack is removed in a horizontal direction parallel to a main surface of the stack, and the analyzing of the image is performed based on at least one of a vertical depth of the pattern and a horizontal distance between adjacent features of the pattern.

13. The method of claim 8, wherein the conductive layer includes a first portion contacting a sidewall of the hole and a second portion contacting a bottom surface of the hole.

14. The method of claim 8, wherein the conductive layer is formed in the hole through a diffusion process.

15. The method of claim 8, wherein the stack includes an insulating material, and the conductive layer includes at least one of a metal, a conductive metal, or a transition metal.

16. The method of claim 8, wherein a horizontal width of the conductive layer formed on a sidewall of the hole is about 30 Å or less.

17. A method of manufacturing a semiconductor device, the method comprising:
preparing a wafer;
performing a semiconductor process on the wafer to form a pattern extending in a vertical direction perpendicular to a horizontal direction, the horizontal direction being parallel to a main surface of the wafer;
inspecting the wafer on which the semiconductor process is performed; and
performing a subsequent semiconductor process on the wafer,
wherein the inspecting of the wafer includes:
stacking a plurality of layers on the wafer to form a stack and then removing a portion of the stack to form a pattern including a hole that extends in the vertical direction;
forming a conductive layer in the hole to manufacture a sample, the conductive layer having an internal space formed therein;
acquiring an image of the sample;
analyzing the image; and
obtaining an inspection result of the wafer based on the analyzing of the image.

18. The method of claim 17, wherein the manufacturing of the sample includes removing a second portion of the stack and a portion of the conductive layer.

19. The method of claim 17, wherein the manufacturing of the sample by removing the portion of the stack is performed by at least one of photolithography, etching, or chemical mechanical polishing (CMP).

20. The method of claim 17, wherein the pattern is at least one of a channel hole structure, a metal contact structure, a through-via structure, or a pillar-type capacitor structure in the semiconductor device.

21. The method of claim 1, wherein the manufacturing of the sample includes:
manufacturing a first sample by removing a second portion of the stack in the vertical direction such that the removed second portion extends in a horizontal plane and has a thickness in the vertical direction, and such that the conductive layer protrudes above an upper surface of a portion of the stack that surrounds the conductive layer,
manufacturing a second sample by removing the second portion of the stack in a horizontal direction parallel to a main surface of the stack such that the second portion extends in a vertical plane and has a thickness in the horizontal direction, and such that the conductive layer protrudes from a side surface of the stack, or
manufacturing a third sample by removing the second portion of the stack in an oblique direction that is not parallel to each of the horizontal direction and the vertical direction such that the stack is divided into sections extending in the horizontal direction, such that upper surfaces of the sections form a staircase shape when viewed along the horizontal direction, and such that the conductive layer protrudes above the upper surfaces of the sections of the stack.

22. The method of claim 21, wherein the manufacturing of the sample includes manufacturing at least two samples selected from among the first sample, the second sample, and the third sample,
wherein the acquiring of the image of the sample includes acquiring images of the at least two samples,
wherein the analyzing of the image includes analyzing the images of the at least two samples, and
wherein the obtaining the inspection result includes obtaining the inspection result of the wafer based on the analyzing of the images.
